(19) United States
(12) Patent Application Publication
(10) Pub. No.: US 2008/0268876 A1
(43) Pub. Date: Oct. 30, 2008

(54) Method, Device, Mobile Terminal, and Computer Program Product for a Point of Interest Based Scheme for Improving Mobile Visual Searching Functionalities

(76) Inventors: Natasha Gelfand, Sunnyvale, CA (US); Ramakrishna Vedantham, Sunnyvale, CA (US); C. Philipp Schloter, San Francisco, CA (US); Radek Grzeszczuk, Menlo Park, CA (US); Wei-Chao Chen, Los Altos, CA (US); Suresh Chitturi, Plano, TX (US); Jiang Gao, Sunnyvale, CA (US); Markus Kahari, Helsinki (FI); David Murphy, Helsinki (FI); Kari Pulli, Palo Alto, CA (US); Ramin Vatanparast, Redwood City, CA (US); Yingen Xiong, Mountain View, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/108,281

(22) Filed: Apr. 23, 2008

Related U.S. Application Data
(60) Provisional application No. 60/913,733, filed on Apr. 24, 2007.

(51) Int. Cl. H04Q 7/20; H04M 1/00

(52) U.S. Cl. 455/457; 455/556.1

(57) ABSTRACT

Systems, methods, devices and computer program products which relate to utilizing a camera of a mobile terminal as a user interface for search applications and online services to perform visual searching are provided. The system consists of an apparatus that includes a processor that is configured to capture an image of one or more objects and analyze data of the image to identify an object(s) of the image. The processor is further configured to receive information that is associated with at least one object of the images and display the information that is associated with the image. In this regard, the apparatus is able to simplify access to location based services and improve a user's experience. The processor of the apparatus is configured to combine results of robust visual searches with online information resources to enhance location based services.

### CROSS REFERENCE TO RELATED APPLICATION

This application is related to and claims the benefit of U.S. Provisional Patent application Ser. No. 60/913,733 filed Apr. 24, 2007, which is hereby incorporated by reference.

### FIELD OF THE INVENTION

Embodiments of the present invention relate generally to mobile visual search technology and, more particularly, relate to methods, devices, mobile terminals and computer program products for utilizing points-of-interest (POI), locational information and images captured by a camera of a device to perform visual searching, to facilitate mobile advertising, and to associate point-of-interest data with location-tagged images.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demands, while providing more flexibility and immediacy of information transfer.

Current and future networking technologies continue to facilitate ease of information transfer and convenience to users by expanding the capabilities of mobile electronic devices. One such expansion in the capabilities of mobile electronic devices relates to modern mobile devices possessing the promise of making Augmented Reality (AR) (which deals with the combination of real-world and computer generated data) practical and universal. There are several characteristics that make mobile devices the platform of choice for developing AR applications. First, new mobile devices are being developed and equipped with broadband wireless connectivity, providing the users of the mobile devices access to vast amounts of information via the World Wide Web anywhere, at anytime. Second, the need for AR is at its highest in a mobile setting since current mobile devices utilize video clips, images and various forms of multimedia to enhance a user's experience. Third, the physical location of the mobile device can be accurately estimated, either through a global positioning system (GPS) or through cell tower location triangulation. The above features make mobile devices an ideal platform for implementing and deploying AR applications and in fact, examples of such applications are currently available and gaining in popularity. A good example is a GPS-based navigation system for smart mobile phones. The software of the smart mobile phone not only provides a user with driving directions, but also uses real-time traffic information to find the quickest way to a destination, and enables a user to find points-of-interest, such as restaurants, gas stations, coffee shops, or the like based on proximity to the current location. A similar application of AR consists of a computer-generated atlas of the Earth that enables a user to zoom in to street level and find point of interests in his/her proximity.

Notwithstanding the fact that mobile devices are implementing and deploying AR applications and that there is a natural progression of the AR applications towards a general mobile search capability, a limiting factor in the adoption of mobile searching relates to difficult and inefficient user-interfacing. Hence a major challenge in developing mobile visual search applications is to enable the search to be easy and simple to use by incorporating non-standard input devices, such as cameras and location sensors into intuitive and robust user interfaces applicable in a mobile setting.

Current versions of mobile visual search applications utilize a centralized database that stores predefined POI images, their corresponding features and the related metadata (textual tags). While current versions of mobile visual search client devices show textual tags corresponding to an image pointed at by a mobile phone's camera, a user may not be interested only in these textual tags, but also in the information about other points of interest (POI) in the surrounding area. This is particularly relevant when the object in the user's immediate vicinity does not have any visual tags, and the user is interested in finding where the visual tags are. Currently, there is no easy way for visualization of the POI data in a mobile visual search client other than displaying of the visual tags that are visible by the mobile phone's camera. As such, the user may have to switch between the mobile visual search client and an external mapping application or a web browser to see the surrounding areas and other tags/POI's.

Another drawback of current mobile visual search clients relates to the POI data displayed on a mobile device when using either an online mapping application (e.g., Smart2Go) or a web browser-based mapping application (e.g., Google Maps, Yahoo Maps) is typically not dynamic. Information resulting from the online mapping application has limited usefulness without a complementing mobile visual search application. Furthermore, existing mapping applications are targeted to only display information about points of interest to the user. In this regard, there exists a need to make use of the fact that a phone is a communication device with a broadband connectivity to expand the scope of visual tags beyond information display to a communication tool. As such, there exists a need to utilize visual tags to communicate with web sites, e-mail clients, online and shared calendars and even other mobile visual search users. There also exists a need to utilize the various online information resources that are available and in order to combine this online information with the results of the mobile visual search applications to generate the next generation mobile device services.

Additionally, as known to those skilled in the art, innovation generates marketing opportunities as well as challenges. In this regard, advances in mobile technology have changed the business environment considerably. As noted above, devices and systems based on mobile technologies are commonplace in our everyday lives and have changed the way we communicate and interact. Phones and multimedia devices increase the accessibility, frequency and speed of communication. As a result, mobile media goes beyond traditional communication and advances one-to-one, many-to-many and fosters mass communication. Today's development in information technology helps marketers to keep track of customers and provide new communication venues for reaching smaller customer segments more cost effectively with more personalized messages. Gradually many more companies are redirecting marketing spending to interactive marketing, which can be focused more effectively on targeted individual consumer and trade segments.

Forecasts concerning growth of mobile advertising have been quite enthusiastic. Mobile advertising holds strong promises to become the best targeted, one-to-one, and most powerful digital advertising medium offering new ways to aim messages to users that existing advertising channels are not able to achieve. The mobile advertising market is estimated to grow to over $600 million during 2007 and is expected to increase to $11.35 billion in 2011. By utilizing mobile advertising, companies can implement marketing campaigns targeted to tens of thousands of people with a fragment of the costs in just a few seconds of time.

Advertising is a strategic marketing tool for businesses, and recently the Internet is becoming a very popular medium for advertising. Current advertising models relating to the Internet are based on traditional search systems which are typically based on text or keyword searches, wherein the text provided by the user with specific criteria is typically used to retrieve a list of items that match those criteria. The results are usually sorted with respect to some measure of relevance to the input provided by the user. Search engines using the text or keyword search concepts are based on frequently updated indexed sets of data for fast and efficient information retrieval. Oftentimes, as the engine is providing relevant information to the user, based on the typed key or content of information, a series of advertisements accompanies the information. The advertisements may also accompany the web-pages which the user is reviewing. This is the most basic form of Internet based advertising.

In contrast, unlike the keyword searches, visual search systems are based on analyzing the perceptual content such as images or video data (e.g. video clips) using an input sample image as the query. The visual search system is different from the so-called image search commonly employed by the Internet, where keywords entered by users are matched to relevant image files on the Internet. Visual search systems are typically based on sophisticated algorithms that are used to analyze the input image against a variety of image features or properties of the image such as color, texture, shape, complexity, objects and regions within an image. The images along with their properties are usually indexed and stored in a database to facilitate efficient visual search.

As noted above, in mobile devices, the concept of visual searches is gaining popularity as more and more devices are being equipped with digital cameras. This provides the ability to generate high quality input query images almost anywhere at anytime, which is by far more advantageous and usable than the visual search systems designed for desktop or personal computer (PC) systems wherein multiple steps are required to generate a query image. For example, in order for a user to perform a visual search of an image on the PC, first the user would need to capture the image from a digital camera, then transfer it to a PC and subsequently perform the search. However, all of these multiple steps can be avoided when using a mobile device equipped with a digital camera.

Currently, Internet advertising models fall mainly into three categories: (1) Impressions, (2) Click-Through's, and (3) Affiliate sales. Impressions consist of a model whereby an advertiser creates a banner advertisement and pays for this banner advertisement to be displayed on another site, for example, on search engine websites. Regarding the Click-Through's model, the seller or advertiser only pays when a visitor clicks on the banner advertisement and goes to the advertiser's site. If the user ignores the banner, then the advertiser is not charged. Affiliate sales model consists of situations in which a seller only pays for advertising when a particular sales target is met.

Although the above-mentioned models are quite successful they come with limitations as they are limited to keyword searches and do not take into account the visual search system and related contextual information such as geo-location, and time including mobility that a wireless terminal offers.

In a dynamic world with constantly evolving advertising media, advertisers need to find new ways to break through the clutter and reach their target consumers. Given the advantages of visual searches to a user/consumer, in the future, consumers are going to use more Visual Search-based advertising as a way to retrieve relevant information. As such, there is a need to create a new system to find relevant advertisements based on searched images/videos. The new system should impact existing advertisement delivery systems and also enable modified existing advertisement delivery systems to effectively target relevant consumers and thereby increase an advertiser's return on investment (ROI) for advertising campaigns. In this regard, visual searches require a unique approach to advertising, highly different from traditional Internet marketing. For the foregoing reasons, the concept of mobile visual searches coupled with contextual information provides various advantages for an end-user and as such, there exists a need to enable advertising in mobile visual search systems, thereby enabling relevant advertisements to be associated with the image/video search.

Point-of-interest (POI) databases are also relevant to mobile visual search systems. For instance, point-of-interest (POI) databases are an integral component of systems for car navigation, computation of directions, on-line yellow pages, and virtual tour guide applications. POI databases typically consist of locations, coupled together with some associated information such as names of businesses, contact information, and web links. A GPS location associated with a given POI is typically computed by interpolating the location of a given street address within a given block. As a result, the location of a POI can often be imprecise. Given the increasing availability of GPS-equipped camera devices, it is now commonplace to acquire geo-tagged images (i.e., images with associated GPS information) of various points-of-interest. (For instance, geo-tagged images may contain geographical identification metadata to various media such as websites, RSS feeds, or images which may consist of latitude and longitude coordinates, though it can also include altitude and place names as well as addresses which can be related to geographic coordinates.) However, there exists a need to be able to automatically associate POI data with geo-tagged images. Automatic association of POI data with geo-tagged images is needed to enable new camera-based user interfaces that retrieve information from POI databases using geo-tagged image matching. Additionally, such an association could be used to correct errors in GPS location present in POI databases and to augment the error correction with information consisting of richer geometric information than is currently available.

When an image is geo-tagged, typically only the position of the camera is given, however, the position of the object that is depicted in the image is typically not provided. Therefore, in cases where there are several objects that can be photographed from the same location (e.g. businesses on two sides of the street photographed from the street median), the position of the camera cannot be used as the position of the object in the image. The imprecision in the GPS position of both the camera and the POIs makes it difficult to associate POI data with images by the naive method of directly matching the GPS coordinates of images and POIs, as is done conventionally.

In view of the foregoing, there also exists a need for a system enabling automatic association of point-of-interest data (POI) with their corresponding images and visual features extracted from the respective images. In conventional systems, skilled artisans are faced with a challenge pertaining to location of images that are geo-tagged which are not necessarily the true physical location of an object(s), or the location associated with this object in a POI database. As such, there exists a need for a mechanism to enable proper association between these different entities so as to improve the accuracy and descriptiveness of the location information in a POI database.

### BRIEF SUMMARY OF THE INVENTION

Systems, methods, devices and computer program products of the exemplary embodiments of the present invention relate to utilizing a camera (e.g., a camera module) of a mobile terminal as a user interface for search applications and online services to perform visual searching. These systems, methods, devices and computer program products simplify access to location based services and improve a mobile users' experience, which in turn can increase the sales of camera phones and also facilitates the launch of new mobile Internet based services. In this regard, new mobile location based services can be created by combining the results of robust mobile visual searches with online information resources.

Systems, methods, devices and computer program products of exemplary alternative embodiments of the present invention provide robust mobile visual search applications displaying relevant information regarding points-of-interest pointed to by a camera of a mobile terminal. The systems, methods, devices and computer program products of the exemplary alternative embodiments of the present invention also provide mapping applications for a mobile terminal and can display relevant visual tags on a map view of a camera of the mobile terminal. Additionally, systems, methods, devices and computer program products of exemplary alternative embodiments of the present invention provide a hybrid of visual searching applications and online web-based applications which are capable of providing a user of a mobile terminal both a global view (of a relevant point-of-interest on a map) and a local view (of the point-of-interest from the camera of the mobile terminal).

Systems, methods, devices and computer program products of another exemplary alternative embodiment of the present invention provide advertising based on mobile visual search systems as opposed to keyword and PC-based searching systems and enables an advertiser(s) to convey information to a consumer on a daily basis, regardless of time of day and location of the user of the mobile terminal. The systems, methods, devices and computer program products of the exemplary alternative embodiments of the present invention also enable advertisers to place tags or associate information with images or one or more categories of images in a visual search database as well as creation of a relevancy link(s) between the information sent by a user of a mobile terminal to a server relating to products and service information. Additionally, the systems, methods, devices and computer program products of the exemplary alternative embodiments of the present invention provide exclusive access or control to advertisers based on a particular region or through global objects/links as well as ease of use with the concept of a “point-through” business model with zero input from a keyboard of a user's terminal, (for e.g., the user is not required to use his/her keyboard to type relating to a keyword search) which reduces the number of steps required by a user/consumer to reach or find relevant information.

In one exemplary embodiment, a method for switching between camera and map views of a terminal is provided. The method includes capturing an image of one or more objects and analyzing data associated with the image to identify an object of the image. The method further includes receiving information that is associated with an object of the images and displaying the information that is associated with the object.

In yet another exemplary embodiment, a method for enabling advertising in mobile visual search systems is provided. The method includes defining and associating meta-information to one or more objects and receiving one or more captured images of objects from a device. The method further includes automatically sending media data associated with an object to the device when the captured images received from the device include data that corresponds to one of the objects.

In another exemplary embodiment, another method of enabling advertising in mobile visual search systems is provided. The method includes defining and storing one or more objects and receiving one or more captured images objects from a device. The method further includes automatically sending media data to the device when the captured images received from the device include data that is associated with one of the defined objects.

In yet another exemplary embodiment, a method for associating images with one or more points-of-interest to determine the location of the point-of-interest is provided. The method includes receiving one or more captured images of objects, removing features from the images and generating a group of images that share one or more features. Each of the images of the group are associated with a point. The method further includes determining whether the group is associated with a shape of an object captured in an image based on a predetermined number of points corresponding to the images of the group, associating the group to a single object when the determination reveals that there are a predetermined number of points and determining the location of at least one object in the images on the basis of the points.

In one exemplary embodiment, an apparatus for switching between camera and map views of a terminal is provided. The apparatus comprises a processing element configured to capture an image of one or more objects and analyze data associated with the image to identify an object of the image. The processing element is further configured to receive information that is associated with an object of the images and display the information that is associated with the object.

In yet another exemplary embodiment, an apparatus for enabling advertising in mobile visual search systems is provided. The apparatus includes a processing element configured to define and associate meta-information to one or more objects and receive one or more captured images of objects from a device. The processing element is configured to automatically send media data associated with an object to the device when the captured images received from the device include data that corresponds to one of the objects.

In another exemplary embodiment, an apparatus for facilitating advertising in mobile visual search systems is provided. The apparatus comprises a processing element configured to define and store one or more objects and receive captured images of objects from a device. The apparatus is further configured to automatically send media data to the device, when the captured images received from the device include data that is associated with one of the defined objects.

In yet another exemplary embodiment, an apparatus for associating images with one or more points-of-interest to determine the location of the point-of-interest is provided. The apparatus comprises a processing element configured to receive captured images of one or more objects, remove features from the images and generate a group of images that share features. Each of the images of the group are associated with a point. The processing element is further configured to determine whether the group is associated with a shape of an object captured in one of the images based on a predetermined number of points corresponding to the images of the group, associate the group to a single object when the determination reveals that there are a predetermined number of points and determine the location of the at least one object of the images on the basis of the points.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a visual search system according to an exemplary embodiment of the invention;

FIG. 4 illustrates a flowchart of a method of switching between camera and map views of a terminal according to an exemplary embodiment of the invention;

FIG. 5 illustrates a server according to exemplary embodiments of the present invention;

FIG. 6 illustrates a map view with superimposed visual tags according to an exemplary embodiment of the invention;

FIG. 7 illustrates a map view with overcrowded visual tags of points-of-interest according to an exemplary embodiment of the present invention;

FIG. 8A illustrates a camera view of a mobile terminal with visual search results according to an exemplary embodiment of the present invention;

FIG. 8B illustrates a map view of a mobile terminal having visual tags according to an exemplary embodiment of the present invention;

FIG. 9 illustrates a flowchart of a method of enabling advertising in mobile visual search systems according to an exemplary embodiment of the invention;

FIG. 10 illustrates a flowchart for associating images with one or more POI(s) to determine the location of the POI according to an exemplary embodiment of the invention; and

FIG. 11 illustrates a system for associating images with points-of-interest.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

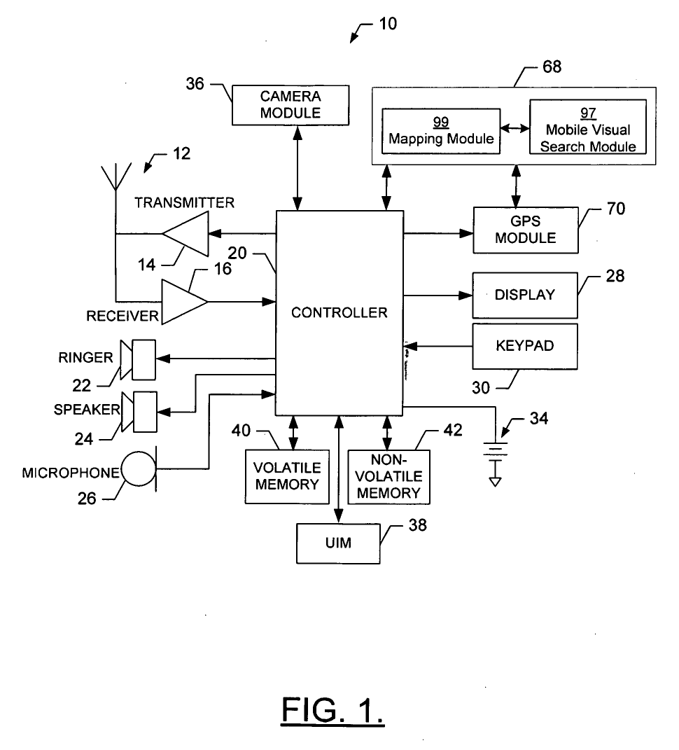

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera module 36 in communication with the controller 20. The camera module 36 may be any means for capturing an image or a video clip or video stream for storage, display or transmission. For example, the camera module 36 may include a digital camera capable of forming a digital image file from an object in view, a captured image or a video stream from recorded video data. As such, the camera module 36 includes all hardware, such as a lens or other optical device, and software necessary for creating a digital image file from a captured image or a video stream from recorded video data. Alternatively, the camera module 36 may include only the hardware needed to view an image, or video stream while a memory device of the mobile terminal 10 stores instructions for execution by the controller 20 in the form of software necessary to create a digital image file from a captured image or a video stream from recorded video data. In an exemplary embodiment, the camera module 36 may further include a processing element such as a co-processor which assists the controller 20 in processing image data or a video stream and an encoder and/or decoder for compressing and/or decompressing image data or a video stream. The encoder and/or decoder may encode and/or decode according to a JPEG standard format, and the like. Additionally, or alternatively, the camera module 36 may include one or more views such as, for example, a first person camera view and a third person map view.

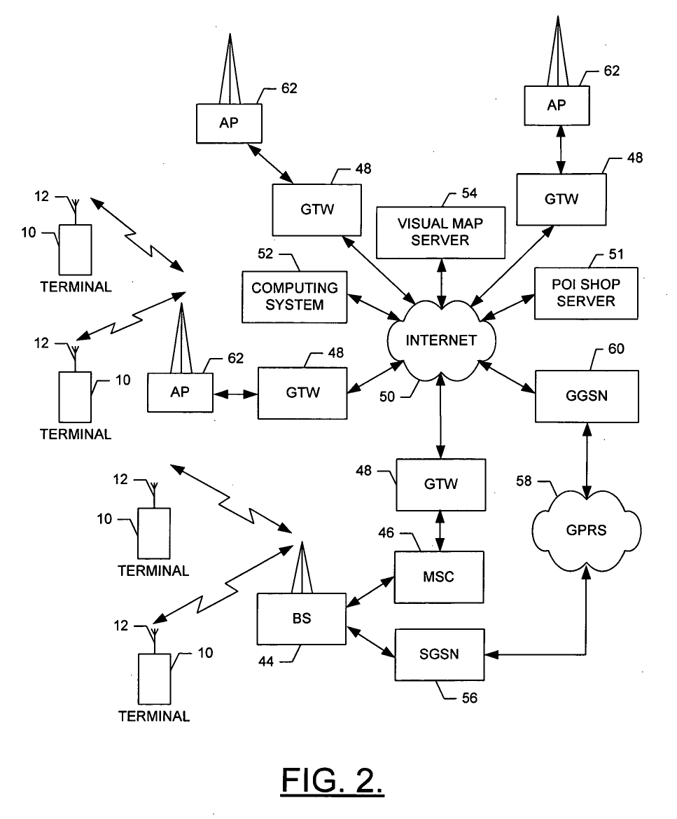

The mobile terminal 10 may further include a GPS module 70 in communication with the controller 20. The GPS module 70 may be any means for locating the position of the mobile terminal 10. Additionally, the GPS module 70 may be any means for locating the position of point-of-interests (POIs), in images captured by the camera module 36, such as for example, shops, bookstores, restaurants, coffee shops, department stores and other businesses and the like. As such, points-of-interest as used herein may include any entity of interest to a user, such as products and other objects and the like. The GPS module 70 may include all hardware for locating the position of a mobile terminal or a POI in an image. Alternatively or additionally, the GPS module 70 may utilize a memory device of the mobile terminal 10 to store instructions for execution by the controller 20 in the form of software necessary to determine the position of the mobile terminal or an image of a POI. Additionally, the GPS module 70 is capable of utilizing the controller 20 to transmit/receive, via the transmitter 14/receiver 16, locational information such as the position of the mobile terminal 10 and a position of one or more POIs to a server, such as the visual map server 54 (also referred to herein as a visual search server), of FIG. 2, and the point-of-interest shop server 51 (also referred to herein as a visual search database), of FIG. 2, described more fully below.

The mobile terminal may also include a unified mobile visual search/mapping client 68 (also referred to herein as visual search client). The unified mobile visual search/mapping client 68 may include a mapping module 99 and a mobile visual search engine 97 (also referred to herein as mobile visual search module). The unified mobile visual search/mapping client 68 may include any means of hardware and or software, being executed by controller 20, capable of recognizing points-of-interest when the mobile terminal 10 is pointed at POIs or when the POIs are in the line of sight of the camera module 36 or when the POIs are captured in an image by the camera module. The mobile visual search engine 97 is also capable of receiving location and position information of the mobile terminal 10 as well as the position of POIs and is capable of recognizing or identifying POIs. In this regard, the mobile visual search engine 97 may identify a POI, either by a recognition process or by location. For instance, the location of the POI may be identified, for example, by setting the coordinates of the POI equal to the GPS coordinates of the camera module capturing the image of the POI, or based on the GPS coordinates of the camera module plus an offset based on the direction that the camera module is pointing, or by recognizing some object within an image based on image recognition and determining that the object has a predefined location, or in any other suitable manner. The mobile visual search engine 97 is also capable of enabling a user of the mobile terminal 10 to select from a list of several actions that are relevant to a respective POI. For example, one of the actions may include but is not limited to searching for other similar POIs (i.e., candidates) within a geographic area. These similar POIs may be stored in a user profile in the mapping module 99. Additionally, the mapping module 99 may launch the third person map view (also referred to herein as camera view) and the first person camera view (also referred to herein as camera view) of the camera module 36. The camera view when executed shows the surrounding area of the mobile terminal 10 and superimposes a set of visual tags that correspond to a set of POIs.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (one shown in FIG. 2), visual map server 54 (one shown in FIG. 2), point-of-interest shop server 51, or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or visual map server 54 may be coupled to the mobile terminal 10 via the Internet 50, SGSN 56 and GGSN 60. In this regard, devices such as the computing system 52 and/or visual map server 54 may communicate with the mobile terminal 10 across the SGSN 56, GPRS core network 58 and the GGSN 60. By directly or indirectly connecting mobile terminals 10 and the other devices (e.g., computing system 52, visual map server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

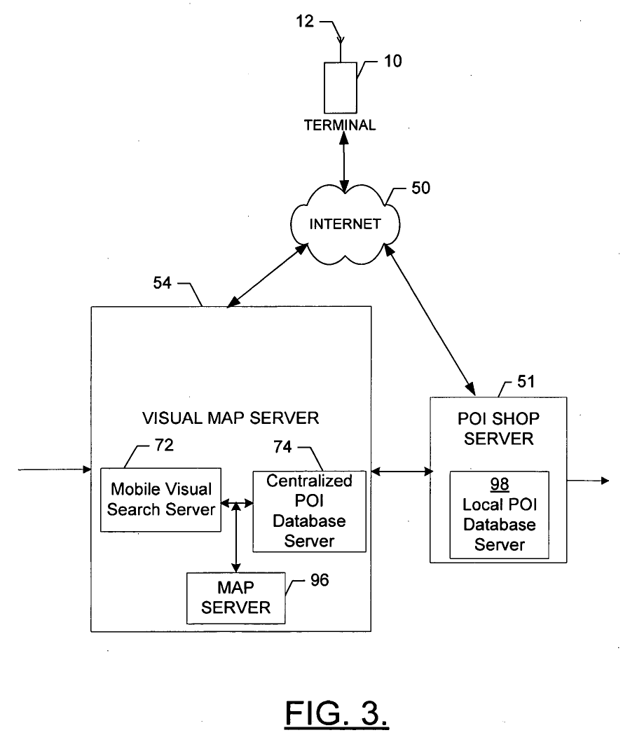

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), Wibree, infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the visual map server 54, and/or any of a number of other devices, to the Internet 50, the mobile terminals 10 can communicate with one another, the computing system, 52 and/or the visual map server 54 as well as the point-of-interest (POI) shop server 51, etc., to thereby carry out various functions of the mobile terminals 10, such as to transmit data, content or the like to, and/or receive content, data or the like from, the computing system 52. For example, the visual map server 54, may provide map data, by way of map server 96, of FIG. 3, relating to a geographical area of one or more mobile terminals 10 or one or more POIs. Additionally, the visual map server 54 may perform comparisons with images or video clips taken by the camera module 36 and determine whether these images or video clips are stored in the visual map server 54. Furthermore, the visual map server 54 may store, by way of centralized POI database server 74, of FIG. 3, various types of information, including location, relating to one or more POIs that may be associated with one or more images or video clips which are captured by the camera module 36. The information relating to one or more POIs may be linked to one or more visual tags which may be transmitted to a mobile terminal 10 for display. Moreover, the point-of-interest shop server 51 may store data regarding the geographic location of one or more POI shops and may store data pertaining to various points-of-interest including but not limited to location of a POI, category of a POI, (e.g., coffee shops or restaurants, sporting venue, concerts, etc.) product information relative to a POI, and the like. The visual map server 54 may transmit and receive information from the point-of interest server 51 and communicate with a mobile terminal 10 via the Internet 50. Likewise, the point-of-interest server 51 may communicate with the visual map server 54 and alternatively, or additionally, may communicate with the mobile terminal 10 directly via a WLAN, Bluetooth, Wibree or the like transmission or via the Internet 50. As used herein, the terms “images,” “video clips,” “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing system 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

An exemplary embodiment of the invention will now be described with reference to FIG. 3 in which certain elements of a visual search system for improving an online mapping application that is integrated with a mobile visual search application (i.e., hybrid) is shown. Some of the elements of the visual search system of FIG. 3 may be employed, for example, on the mobile terminal 10 of FIG. 1. However, it should be noted that the system of FIG. 3 may also be employed on a variety of other devices, both mobile and fixed, and therefore, embodiments of the present invention should not be limited to application on devices such as the mobile terminal 10 of FIG. 1 although an exemplary embodiment of the invention will be described in greater detail below in the context of application in a mobile terminal. Such description below is given by way of example and not of limitation. For example, the visual search system of FIG. 3 may be employed on a camera, a video recorder, etc. Furthermore, the system of FIG. 3 may be employed on a device, component, element or module of the mobile terminal 10. It should also be noted that while FIG. 3 illustrates one example of a configuration of the visual search system, numerous other configurations may also be used to implement the present invention.

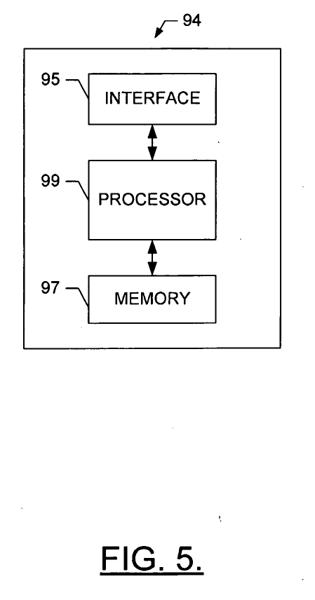

Referring now to FIG. 3, a visual search system for improving an online mapping application that is integrated with a mobile visual search application (i.e., hybrid) is provided. The system includes a visual search server 54 in communication with a mobile terminal 10 as well as a point-of-interest shop server 51. The visual search server 54 may be any device or means such as hardware or software capable of storing map data, in the map server 96, POI data and visual tags, in the centralized POI database server 74 and images or video clips, in the visual search server 54. Moreover, the visual map server 54 may include a processor 99 for carrying out or executing these functions including execution of the software. (See e.g. FIG. 5) The images or video clips may correspond to a user profile that is stored on behalf of a user of a mobile terminal 10. Additionally, the images or video clips may be linked to positional information pertaining to the location of the object or objects captured in the image(s) or video clip(s). Similarly, the point-of-interest server 51 may be any device or means such as hardware or software capable of storing information pertaining to points-of-interest. The point-of-interest shop server 51 may include a processor (e.g., processor 99 of FIG. 5) for carrying out or executing functions or software instructions. (See e.g. FIG. 5) The images or video clips may correspond to a user profile that is stored on behalf of a user of a mobile terminal 10. This point-of-interest information may be loaded in a local POI database server 98 (also referred to herein as a visual search advertiser input control/interface) and stored on behalf of a point of interest shop (for e.g., coffee shops, restaurants, stores, etc.) and various forms of information may be associated with the POI information such as position, location or geographic data relating to a POI, as well, for example, product information including but not limited to identification of the product, price, quantity, etc. The local POI database server 98 (i.e., visual search advertiser input control/interface) may be included in the point-of-interest shop server 51 or may be located external to the POI shop server 51.

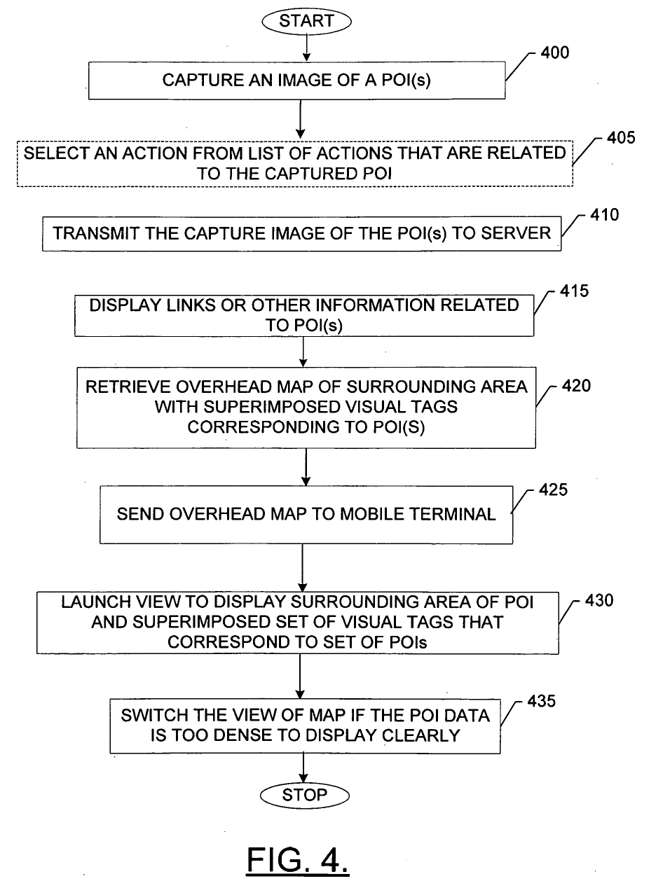

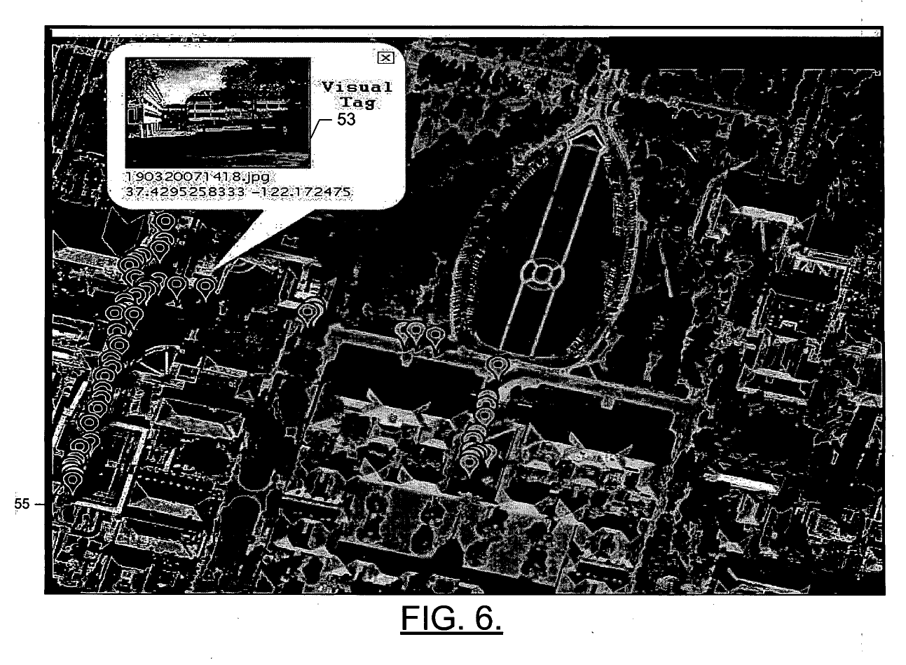

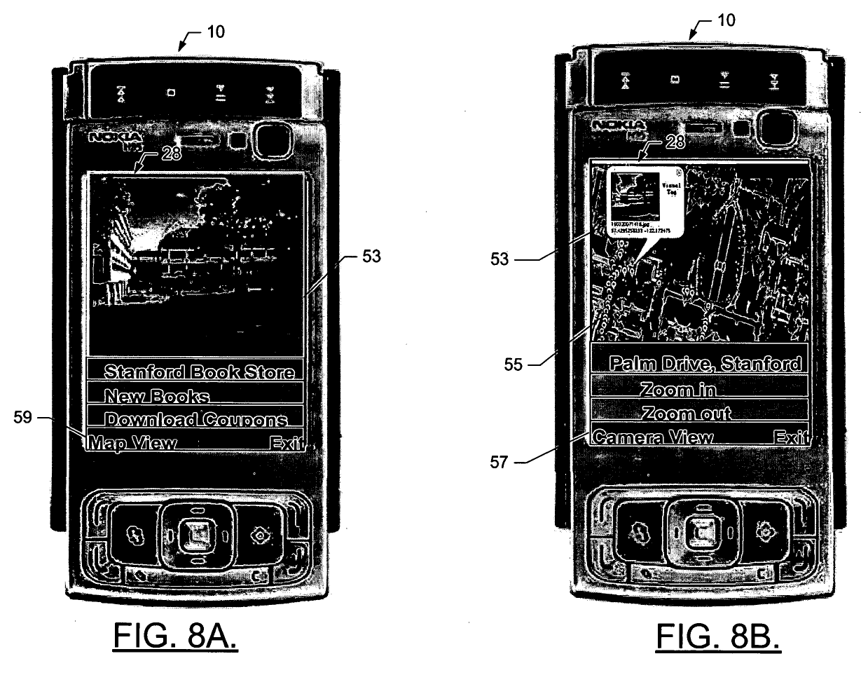

Referring now to FIG. 4, a flowchart of a method of switching between camera and map views of a mobile terminal is illustrated. In the exemplary embodiment of the visual search system of FIG. 3, a user of a mobile terminal 10 may need to, or desire to, switch from the “first person” camera view 57 (See FIG. 8B) of the camera module 36, which is used in a mobile visual search, to the “third person” map view 59 of the camera module 36 (See FIG. 8A). In order to switch between the views, a user currently in the camera view may launch the unified mobile visual search/mapping client 68 (using keypad 30 or alternatively by using menu options shown on the display 28) and point the camera module 36 at a point-of-interest such as for example, a coffee shop and capture an image of the coffee shop. (Step 400) The mobile visual search module 97 may invoke a recognition scheme to thereby recognize the coffee shop and it allows the user to select from a list of several actions, displayed on display 28 that are relevant to the given POI, in this example the coffee shop. For example, one of the relevant actions may be to search for other similar POIs (e.g. other coffee shops) (i.e., candidates or candidate POIs). (Optional Step 405) Additionally, the unified mobile visual search/mapping client 68 may transmit the captured image of the coffee shop to the visual search server 54 and the visual search server may find and locate other nearby coffee shops in the centralized POI database server 74. (Step 410) Based upon the location of the recognized coffee shop, the visual search server 54 may also retrieve from map server 96 an overhead map of the surrounding area which includes superimposed visual tags corresponding to other coffee shops (or any physical entity of interest to the user) relative to the captured image of the coffee shop. (Step 415) The visual search server 54 may transmit this overhead map to the mobile terminal 10 which displays the overhead map of the surrounding area including the superimposed visual tags corresponding to other POIs such as for e.g. other coffee shops. (See e.g. FIG. 6) (Step 420)

The map view is beneficial in the example above, because the camera view alone may not provide the user with information pertaining to the other visual tags in his/her neighborhood. Instead, the camera view displays information/actions for its currently identified visual tag, i.e., the captured image of the coffee shop in the above example. The user can then use a joystick, arrows, buttons, stylus or other input modalities known to those skilled in the art on the keypad 30 to obtain more information pertaining to other nearby tags on the map.

Referring to FIG. 5, a block diagram of server 94 is shown. As shown in FIG. 5, server 94 (which may the point-of-interest shop server 51, local POI database server 98, the visual search advertiser input control/interface, centralized POI database server 74 and the visual search server 54) is capable of allowing a product manufacturer, product advertiser, business owner, service provider, network operator, or the like to input relevant information (via the interface 95) relating to a POI, such as for example web pages, web links, yellow pages information, images, videos, contact information, address information, positional information such as waypoints of a building, locational information, map data and the like in a memory 97. The server 94 generally includes a processor 99, controller or the like connected to the memory 97. The processor 99 can also be connected to at least one interface 95 or other means for transmitting and/or receiving data, content or the like. The memory can comprise volatile and/or non-volatile memory, and typically stores content relating to one or more POIs, as noted above. The memory 97 may also store software applications, instructions or the like for the processor to perform steps associated with operation of the server in accordance with embodiments of the present invention. In this regard, the memory may contain software instructions (that are executed by the processor) for storing, uploading/downloading POI data, map data and the like and for transmitting/receiving the POI data to/from mobile terminal 10 and to/from the point-of-interest shop server as well as the visual search server.

Referring now to FIG. 6, FIG. 6 shows a map view with superimposed POIs 55 and visual tags 53. The pegs in the map correspond to relevant points-of-interest 55 and the visual tag(s) 53 shows an enlarged image relative to a POI(s). The visual tag 53 may contain information about the image, displayed therein. The map view 59 of the camera module 36 is also beneficial if there are no visual tags 53 in the user's immediate visible area, given that the map view provides indications of where the nearest visual tags/POIs are located.

A situation exists in which the map view of the camera module 36 may not be adequate, by itself, to create a sufficient user interface for mobile visual searching. For example, a user of a mobile terminal 10 may invoke or launch the proposed unified mobile mapping/visual search client 68 and immediately open the map-view. The map view shows the surrounding area and superimposes a set of visual tags 53 that correspond to a set of POIs 55. (Step 430) When the user moves a pointer on to a visual tag, the display 28 of the mobile terminal may show an image of that POI and may also display some textual tags that contain relevant links or more information, such as websites or uniform resource locators or the POI. The POI data is dynamically loaded from one or more databases such as local POI database server 98 and centralized POI database server 74. However, in some locations (e.g., shopping centers), the POI (e.g. grocery store) data may be too dense to display clearly on the map view of the mobile terminal 10. That is to say, the POIs may appear very crowded to a user of the mobile terminal 10. (See e.g. FIG. 5). As such, the user may not be able to pin-point a specific visual tag using regular input modalities like a joystick/arrows/buttons/stylus/fingers. If this situation arises, a user may point the camera module 36 at any specific location (for instance a shop) or capture an image of the specific location and the mobile visual search module 97 provides relevant information based on image matching. The above-example shows that there may be instances where it is beneficial to switch from the third person map view to the first person camera view in order to disambiguate among different visual tags on a crowded map view application.

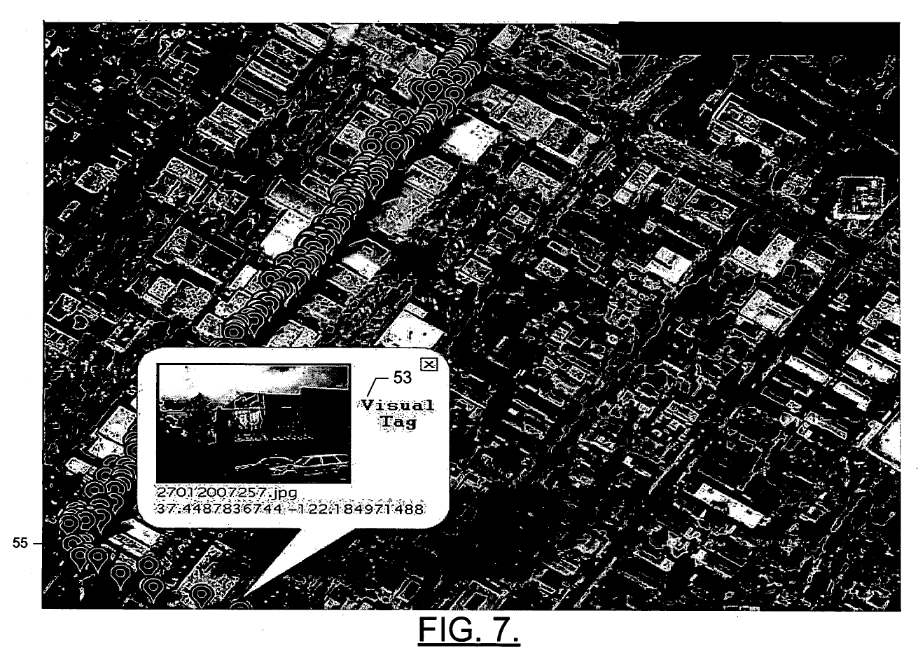

Referring to FIG. 7, FIG. 7 shows a map view with over crowded visual tags 53 of points-of-interest. As can be seen in FIG. 7 and as noted above, this overcrowding occludes some visual tags and switching to the camera view 57 of the camera module 36 and subsequent mobile visual search can clearly identify the underlying visual tag. This can be seen in FIGS. 8A and 8B wherein FIG. 8A illustrates an example of a camera view mobile visual search results and FIG. 8B illustrates an example of the map view with visual tags. As can be seen in FIG. 8A in the map view of the camera module 36, there is overcrowding of visual tags of points-of-interest, which occludes some visual tags and points-of-interest on the display 28. As such, it may become desirable for the user to switch to the camera view of the camera module as shown in FIG. 8A so that a relevant visual tag 53 corresponding to a POI, here Standford Book Store can be adequately displayed by display 28. (Step 435) In other words, the unified mapping/visual search module 68 enables the user to easily switch between the map view and camera view of the bookstore shown in visual tag 53. The user is therefore able to obtain relevant information at various granularities depending on the view of the camera module 36.

The visual tags 53 are dynamic in nature and can depend on the preferences of a user. For instance, if a user sets a POI to be a product such as a plasma television sold at a particular store and the store subsequently ceases to continue selling the product, the user may want to update or revise his/her user preferences to a POI which currently sells the plasma television. Additionally, if a POI is a product which changes locations or positions, an owner of the product might want to update the product information associated with the POI and as a result of this change or modification, an updated or revised visual tag 53 is also generated. As noted above, if the display of the mobile device shows all POIs on the map view of the display 28 of the mobile terminal 10, the display of the map view may be over-crowded. However, if a user is only interested in some types of POIs, for example, coffee shops and/or Chinese restaurants, then the unified mobile visual search/mapping module 68 should be invoked by the user to only display POIs of interest in the map view, in this example additional coffee shops and Chinese restaurants. In this regard, user interest in a specified category of POIs significantly reduces the number of POIs that may be displayed in the map view. In addition, the user of the mobile terminal is able to easily manage his/her POI preferences in a user profile that is stored in a memory element of the mobile terminal 10 such as volatile memory 40 and/or non-volatile memory 42.

In an exemplary embodiment of the system of FIG. 3, there are two classes of visual tags consisting of: (1) general POIs such as, for example, stores and restaurants that come with existing mapping applications and give the user an idea of interesting places in his/her surrounding area; and (2) transient tags such as visual tag information about products within a given store, which are only relevant when the user is in the immediate or very close proximity of those tags. However, in other exemplary embodiments of the visual search system of FIG. 3, there may be any number of classes of visual tags.

Although POIs in mapping and yellow pages applications do not get updated often, there may be lists of community-generated POIs that are likely to require frequent updates and re-downloading due to their dynamic nature, such as products that are on lists or in a user profile, as noted above. As such, the unified mobile mapping/visual search module 68 is capable of obtaining visual tags via a really simple syndication (RSS)-type subscription(s) which may be used to obtain frequently updated content in the form of streams from some of the POI's websites.

The following situation(s) illustrates the relevance of streaming of visual tags to the mobile terminal 10 which may be based, in part, on location. Consider a scenario in which a user walks to a store. Visual tag information relating to the products in that store may be loaded on his/her mobile terminal 10. (For example, the visual tag information related to the products may be triggered automatically and loaded to the mobile terminal based on the user's proximity to the store, or specifically requested by the user if automatic tag streaming conflicts with the user's privacy settings in his/her user profile. The automatic triggering may be performed without user interaction with the mobile terminal in an exemplary alternative embodiment.) The visual tags 53 are streamed from the store's server such as for example from point-of-interest shop server 51 directly to the mobile terminal or alternatively, may be routed through a system server such as for example, visual search server 54, to the mobile terminal. The layout of the store or shop itself may also be streamed to the mobile terminal. In another scenario, a user may enter the store and point the camera module at any product(s) and capture a corresponding image(s). The visual search system of FIG. 3, via the mobile visual search server, is capable of matching the captured image(s) with any of pre-loaded visual tags which may be stored at the centralized POI database server 74, and provides information, corresponding to an object associated with the visual tag(s), to the mobile terminal. Alternatively, the visual search system of FIG. 3 may also display the layout of the store or shop in the map view and superimpose the visual tags of the products of interest on a shop view of the camera module (not shown). This may be performed by the visual search server when the visual map server 96 receives relevant information relating to the layout of the store or shop from the local POI database server 74 and transmits this information to the mobile terminal. When the user leaves the store, the visual tags and store layout are set to be inactive. The visual tags and the store layout may also be removed from the mobile terminal's memory when there is no space remaining on a memory element of the mobile terminal.

As noted above, RSS streaming of frequently changing visual tags is applicable when the locations or number of the objects of interest changes frequently due to a community's input (best fishing spots, best place to buy shoes, etc.). In general, by allowing the streaming of community-generated visual tags to a mobile terminal and visual tag subscription services, the concept of a POI as a location of a store/business/physical object is expanded from a mapping application(s) to a POI relating to any information associated with a geographic location.

For interoperability, the POI data of the exemplary embodiments of the present invention is standardized. The standardized format of the POI data has at least the following fields: (1) name; (2) location (GPS); (3) location (address); (4) information to display on an overhead map view (e.g., icon, text); (5) information to display on a small resolution screen in first person view (e.g., camera view); and (5) information to display on large screen (such as, for example, when browsing visual tags on a PC).

Given the broadband and multi-radio connectivity available to the mobile users, the unified mobile visual search/mapping client 68 of the present invention, which performs, among other things, mobile visual searching is not limited to a mapping application/information display tool. To be precise, the unified mobile visual search/mapping client 68 of the present invention may also combine visual searches and online services, such as for example, Internet based services.

To illustrate this point, consider the following example in which visual searches are combined with online services. A small business owner can create an online presence (such as a Website) for his store or business, (or auction site) etc. by merely using a mobile terminal. The online presence or Website may be generated by pointing the camera module 36 at a product(s) within the store, capturing image(s) of the product(s) and creating associated visual tags for the product(s) in his/her store, shop or business and the like. Creation of associated visual tags may be performed by the business owner by generating metadata pertaining to a respective product, including but not limited to price, an image of the product, description a URL for the product, etc. For instance, the business owner may point his/her mobile terminal 10 at a camcorder and capture an image of the camcorder and generate a visual tag and use the keypad 30 to enter text such as the price of the camcorder, the camcorder's specifications, and a URL of camcorder's manufacturer. Also, the business owner may link an image of the camcorder to the metadata forming the visual tag. However, if the business owner wishes, he/she can provide additional information about how to contact the store or business by e-mail, short messaging service (SMS), a customer service number, or provide a logo of the business and the like. All information from the visual tags as well as the contact information can be bundled into visual tags for mobile visual searches performed by the visual search server 54. For instance, the visual tags created by the business owner can be loaded into the local POI database server 74 and alternatively or additionally be uploaded to the visual search server 54, as in the case of mobile visual searches discussed above. As such, the visual search server 54 may receive the visual tags created by the business owner and use a software algorithm to store information relating to the visual tags on a website set up on behalf of the business owner. Alternatively, an operator of the visual search server 54 may utilize the visual tags received from the business owner to generate or update the Website on behalf of the business owner. Additionally, the information in the visual tags 53 could be streamed, for example via RSS subscriptions, to the unified mobile visual search/mapping client 68 of the mobile terminal when the unified mobile visual search/mapping client 68 approaches the physical location of the store with the mobile terminal.

In one embodiment, the information from the visual tag(s) may be streamed to the mobile terminal automatically upon the user of the mobile terminal entering a predefined range of the store or business without further user interaction. If the business owner chooses to update one or more of the visual tags in the store or business, the information associated with the updated visual tag(s) is automatically updated on the business owner's website (i.e., the store website) once the visual search server 54 receives the updated information relative to the updated visual tags. For example, a software algorithm of the visual search server 54 (or alternatively an operator of visual search server 54) updates information on the business owner's website when visual tag information relating to the camcorder is updated. As illustrated above, the same visual tags that are uploaded to the visual search server 54 can be used by the visual search server 54 to create a Website for the business owner, thereby providing the business owner an easy mechanism for creating an online presence for his/her store without even having to use or own a computer. Due to the combined integration of visual searches with online services, discussed above, the business owner may utilize the visual search server 54 to acquire a Website (having a URL and/or a domain name) even in instances in which he/she lacks the requisite technical skill or resources (e.g., the user lacks a PC or computing system 52) to establish the Website himself/herself.

In an exemplary alternative embodiment, the mobile terminal 10 may utilize the visual tags 53 to trigger certain actions. For instance, when a user points his/her camera module 36 at any physical entity (POI) such as for example, a restaurant and captures a picture/image of the restaurant, the user may enable a shortcut key using keypad 30, (or using a pointer or the like to select from a list (e.g. a menu or sub-menu) of actions) the user may trigger the unified mobile visual search/mapping client 68 to add the information pertaining to the entity, such as the restaurant to the user's address book, or send him/her a reminder, such as for example, to visit this restaurant later, and include in the reminder other information, such as other information relating to the restaurant retrieved from the Internet 50, such as ratings and reviews of the restaurant.

The mobile terminal 10 of the present invention can also send a visual tag(s) (received from the visual map server 54 for a respective object that the camera module 36 was pointed at, such as any physical entity, including but not limited to a business or restaurant) to users of other mobile terminals who utilize mobile visual search features, and may use the sent visual tag(s) as an invitation to meet the user sending the invitation at the entity (e.g., restaurant) at a given time. The mobile terminal 10 of the user(s) who received the invitation would utilize his/her unified mobile visual search/mapping client 68 to schedule the invitation as an appointment in his/her calendar stored in the mobile terminal, and at the appropriate time provide the mobile terminal with reminders and navigation directions to reach the destination.

In view of the foregoing, a camera such as camera module 36 may be used as an input device to select visual tags within a user's proximity or geographic area. As explained above, the camera module 36 may be used with mapping tools to display other visual tags farther away from the user to provide information about user's surroundings. Additionally, as noted above, the camera module 36 and mobile visual search tools of embodiments of the present invention enable the use of ubiquitous connectivity to update and share the visual tags, as well as to seamlessly combine information stored in the visual tags with information online.

In an alternative exemplary embodiment of the visual search system of FIG. 3, the visual search system is capable of enabling advertising in mobile visual search systems. The visual search system of this alternative exemplary embodiment allows advertisers to place information into a visual search database 51. Such information placed in the visual search database 51 includes but is not limited to media content associated with one or more objects in a real world, and/or meta-information providing one or more characteristics associated with at least one of the media content, the mobile terminal 10, and a user of the mobile terminal. For example, the media content may be an image, graphical animation, text data, digital photograph of a physical object (e.g., a restaurant facade, a store logo, a street name, etc.), a video clip, such as a video of an event involving a physical object, an audio clip such as a recording of music played during the event, etc. The meta-information can be relevancy information such as tags to the images in the visual search database 51 such as web links, geo-location information, time, or any other form of content to be displayed to the user. For instance, the meta-information may include, but is not limited to, properties of media content (e.g., timestamp, owner, etc.), geographic characteristics of a mobile device (e.g., current location or altitude), environmental characteristics (e.g., current weather or time), personal characteristics of the user (e.g., native language or profession), characteristics of user(s) online behaviour (e.g., statistics on user access of information provided by the present system), etc.

The visual search system of this embodiment also allows a user to map visual search results to specific custom actions such as invoking a web link, making a phone call, purchasing a product, viewing a product catalogue, providing a closest location for purchase, listing related coupons and discounts or displaying content representation of product information of any kind including graphical animation, video or audio clips, text data, images and the like. The system may also provide exclusive access to the advertisers based on certain categories of products such as books, automobiles, consumer electronics, restaurants, shopping outlets, sporting venues, and the like. Furthermore, the system may provide exclusive access to global links to information based on a user's context independent of visual search results, such as weather, news, stock quotes, special discounts, etc. and may provide a notion of “point-through” advertising, as opposed to “click-through” advertising, wherein the user can navigate to a particular information store, such as for example an online navigation store, by simply pointing a camera-enabled device, such as camera module 36, without performing any clicks or selection of links such as URLs and the like. For instance, a user may point his/her camera module 36 at an object and capture an image. The captured image may invoke a web browser of the mobile terminal 10 to retrieve one or more relevant web links. In this regard, the web links can be accessed simply by pointing the camera module 36 at an object of interest to the user, i.e., a point-of-interest. As such, a user is not required to describe a search in terms of words or text.

In the visual search system of this exemplary embodiment, the visual search client 68 controls the camera module's image input, tracks or senses the image motion, is capable of communicating with the visual search server and the visual search database for obtaining information relating to a relevant target object (i.e., POI) and the necessary user interface and mechanisms for displaying the appropriate results to the user of the mobile terminal 10. Additionally, the visual search server 54 is capable of handling requests from the mobile terminal and is capable of interacting with the visual search database 51 for storing and retrieving visual search information relating to one or more POIs, for example. The visual search database 54 is capable of storing all the relevant visual search information including image objects and its associated meta-information such as tags, web links, time, geo-location, advertisement information and other contextual information for quick and efficient retrieval. The visual search advertiser input control/interface 98 is capable of serving as an interface for advertisers to insert their data into the visual search database 54. A control of the visual search advertiser input control/interface 98 is flexible regarding the mechanism in which data may be inserted into the visual search database, for example, the data can be inserted into the visual search database based on location, image, time or the like as explained more fully below. This mechanism for inserting data into the visual search database 54 can also be automated based on factors such as spending limit, bidding, or purchase price, etc.

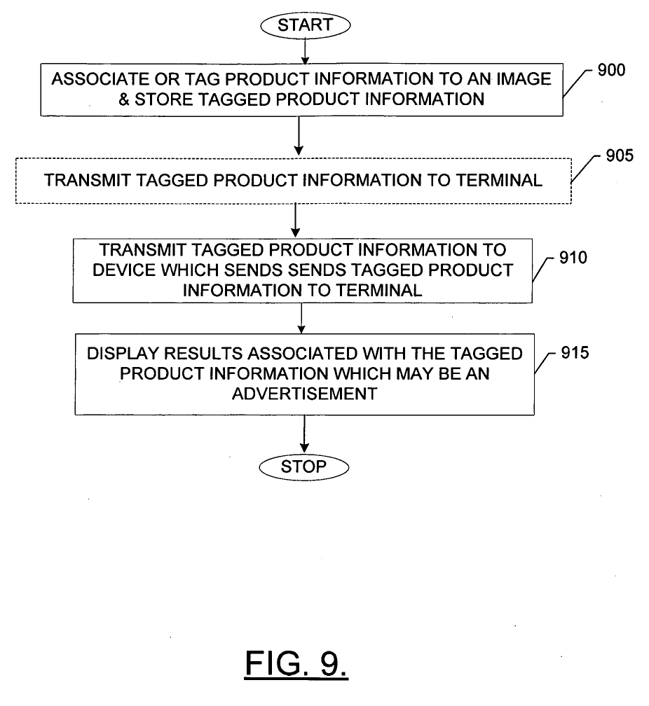

Referring to FIG. 9, a flowchart for a method of enabling advertising in mobile visual search systems is provided. To illustrate the advertising mobile visual search system of this exemplary embodiment of the present invention, consider the following scenarios. In a shopping context, suppose a user having mobile terminal 10, which is equipped with camera module 36 and is enabled with mobile visual search client 68 walks into a shopping centre, looks at a product (for e.g., a camcorder), and would like to know more information about the product. In this situation, a product manufacturer, advertiser, business owner or the like can associate or tag a product information link to an image of the product, such as the camcorder, by using an interface 95 of the visual search advertiser input control/interface 98 and store the product information link in a memory of the visual search database 51. (Step 900) In this regard, the user would be able to obtain a web link to the product information page (e.g. online web page for the camcorder) immediately upon pointing his/her camera module 36 at the product, or taking a picture of the product by using the visual search client 68 of the mobile terminal 10. For instance, once the product manufacturer, business, owner, etc. stores the information relating to the product (in this e.g. a web link) in the visual search database, this information may be transmitted directly to the visual search client of the mobile terminal 10 for processing. (Step 905) Alternatively, this information may be stored in the visual search database 51, and may be transmitted to the visual search server 54 and then the visual search server 54 sends the information relating to the product(s) to the visual search client 68 of the mobile terminal 10. (Step 910) In this regard, the visual search client 68 controls the camera module's image input, tracks or senses the image motion, is capable of communicating with the visual search server and the visual search database for obtaining information relating to a relevant target object (i.e., POI) and the necessary user interface and mechanisms for displaying the appropriate results to the user of the mobile terminal 10. (Step 915) Additionally, the product manufacturer, advertiser, or business owner could also insert other forms or advertisements such as text banners, animated clips or the like into the information related to the product (for e.g., the online website relating to the camcorder).

In the context of tourism, a user of mobile terminal 10 may take a picture or point his/her camera module 36 at a landmark of interest (i.e., POI) to obtain more information relevant to the landmark. By using the visual search system of the present invention, the advertisers can insert tags (in the manner discussed above) associated with the landmark which may include links to relevant information to be provided to the user such as for example, available tourist packages, most popular restaurants nearby along with review guides of these restaurants, best souvenirs, a web link to driving directions on how to arrive at a destination near the landmark, and the like. As another example, consider the context of movies. Suppose a user of a mobile terminal 10 is walking in a downtown area of a city and notices a movie poster and would like to know more information about the movie, such as for example, reviews or ratings about the movie, show times, a short trailer in the form of video clip, and nearby theatres that are showing the movie or a direct web link to purchase the tickets to the movie. All this information can be obtained by simply pointing the camera module 36 of mobile terminal 10 at the movie poster or capturing an image of the movie poster. In this regard, advertisers could benefit by adding their poster images to the visual search database, via the visual search advertiser input control/interface 98, and tagging associated information to the image with necessary geo-location information. For instance, the advertisers could associate movie show times, ratings and reviews, video clips etc. to the image of the poster and charge a movie company or movie theatre for example for this service.

The visual search system of this exemplary embodiment allows for multiple implementation alternatives for advertisers based on their needs, scope and other factors for example budget constraints. These implementations can be categorized as follows: (1) brand availability; (2) location control; (3) tag re-routing; (4) service ad insertion; (5) point ad insertion; and (6) access to global links. Each of these six implementations will be discussed in turn below.

Brand availability: The brand availability implementation allows advertisers to insert new objects representing images relevant to their brand (e.g. the PEPSI logo) into the visual search database 51. The advertisers can use the visual search advertiser input control to insert the objects into the visual search database. In this regard, the advertisers are able to insert advertisement media (i.e., objects) into the visual search database. This advertisement media may include but is not limited to images, pictures, video clips, banner advertisements, text messages, SMS messages, audio messages/clips, graphical animations and the like. In addition to the objects or their features, the objects can contain associated tags or any other kind of information (such as the advertisement media noted above) to be presented to the mobile terminal of the user to facilitate their advertisement needs. The advertisers may utilize the visual search advertiser interface control 98 to associate meta-information to the objects (e.g. PEPSI logo). As noted above, the meta-information may include location information (e.g. New York City or Los Angeles), time of day, weather, temperature or the like. This meta-information may also be stored in the visual search database 51 and provided to or transmitted to the visual search server 54 on behalf of the advertiser. When the user points the camera module 36 at an object or captures an image of the object, the visual search client 68 sends an image of the object to the visual search server 54 which examines the meta-information in the image(s) and determines if it matches one or more of the meta-data information established by the advertiser, the visual search server 54 is capable of sending the visual search client 68 of the mobile terminal 10 an advertisement on behalf of the advertiser. For example, if the image captured by camera module 36 has information associated with it identifying its location such as New York City and a temperature or specifies the current weather where the user of the mobile terminal is located, the visual search server 54 may generate a list of candidate advertisers (e.g., PEPSI, DR. PEPPER, etc.) to choose from as well as candidate forms of advertisement media to be provided to the user (e.g., brand logo, video clip, audio message, etc.). The visual search server, matches the information in an image captured by the camera module 36 with the meta-information set up by the advertiser and sends the user of the mobile terminal a suitable form of advertisement such as for example, an image of a logo, such as for example, a PEPSI logo, which may be displayed on the display 28 of the mobile terminal 10.

The received advertisement media could cover a part of display 28 or all of display 28 depending on a choice of the respective advertiser and display options set up by the user of the mobile terminal 10. It should be pointed out that once the camera module 36 is pointed at a relevant object, the visual search client 68 could also be provided, by the visual search server, with a web link to an advertisement, a yellow page entry of an advertisement, a telephone call having an audio recording of an advertisement, a video clip of an advertisement or a text message relating to an advertisement. The advertisers could change the originally established meta-information or media information that it would like presented to the user by updating this information in the visual search database 51 via the visual search advertiser input control/interface 98. Additionally, once an advertiser has uploaded a form of media such as a brand logo, the advertiser can later change the association, so that they will have a new promotion or advertisement based on certain meta-information identified in an image captured by the camera module 36. For example, based on the time of day, where the user of the mobile terminal is located, the user could be provided with a promotional video trailer relating to PEPSI products (or any other product(s)).

It should be pointed out that the advertiser(s) could pay an operator of the visual search server for the service of sending the advertisements to the user of the mobile terminal 1O. Moreover, it should also be pointed out that the brand availability implementation impacts both a change in a service recommendation system and in the visual search database which stores objects and associated content. In other words, the brand availability implementation allows advertisers to change a service request from the visual search client and also the objects used in the visual search database, for instance the advertisers must provide their logos, video clips, audio data, text messages and the like into the visual search database, which are associated with meta-information.

Location Control: The location control implementation enables advertisers to gain exclusive access or control over a specific location or geographic area/region. For instance, the advertiser can purchase the rights to advertise a specific category of product(s) (e.g., books) for a particular location or region (e.g., California), and assign specific actions to visual tags (e.g., web links to products). For instance, an owner/advertiser of a book store called “Book Company X” might decide that he/she wants to purchase the exclusive right to supply advertisements provided by the visual search system. In this regard, the owner may purchase this right from an operator of the visual search server 54. The owner/advertiser may utilize the visual search advertiser input control/interface 98 to associate information with his/her products such as for example, creation of web links showing the products in his/her store, listing information such as price of products, store hours, store contact information, the store's address, business advertisement in the form of an image, video, audio, text data, graphical animation, etc. and store this information in the visual search database 51 which can be uploaded, sent or transmitted to the visual search server 54. Additionally, the owner/advertiser can associate meta-information (e.g., geo-location, time of day/year, weather, or any other information chosen by the owner/advertiser) with the product information stored in the visual search database and in the visual search server. As such, when the user of the mobile terminal points the camera module 36 at an object (i.e., POI), for example, a book or novel in a library, or captures an image of the object, (e.g., a bookshelf) the image can be sent to the visual search server by the visual search client. The visual search server 54 determines if any information in the received image(s) relates to the meta-information established by the owner/advertiser and determines whether the user of the mobile terminal is located in the geographic area in which the advertiser/owner has purchased exclusive rights and if so, the visual search client of the mobile terminal 10 is provided with information associated with products in the Book Company X. Since the owner of Book Company X has paid for the exclusive right in a geographic region (e.g., Northern California or Northern Virginia), the visual search server will not provide advertisement data for products categorized as books in these geographic regions/areas to another advertiser/owner of a business.

As noted above, a Book Company X can obtain exclusive control of all users interested in information related to products categorized as books and offer related services to users of the mobile terminal. As a practical matter, any user within a region looking for any product related to a specified category (in the e.g. above books) could be presented with a service or advertisement offered by the advertiser (in the e.g. above Book Company X). The location control implementation, allows for changes in service recommendations since the list of candidates may change, i.e., Business owner A/Advertiser A may decide not to renew his/her exclusive rights to the geographic area and Business owner B/Advertiser B may decide to purchase the exclusive right to the respective geographic area (e.g., Northern California and Northern Virginia). Additionally, the location control implementation requires a change in content/objects stored in the visual search database since the advertisers must insert their product information into the visual search database, such as web links, store contact information or a video clip advertisement for the store or the like.

Tag re-routing: The tag re-routing technique provides the ability for an advertiser to re-route the service for a particular tag (i.e., information associated with one or more products, objects, or POIs) based on the title, location, time, or any other kind of contextual information, i.e., meta-information. Suppose a company/advertiser such as BARNES AND NOBLE® bookstore created tags i.e., associated product information to objects such as for example books and created meta-information associated with these tags in the manner discussed above for the brand availability and the location control implementations. As discussed above, these tags and meta-information may be stored in the visual search database and the visual search server and when the visual search server 54 receives an image that was pointed at by the camera module of the mobile terminal 10, such as, for example, a bookshelf, the visual search server may provide the visual search client with information in the form of a media advertisement from BARNES AND NOBLE® bookstore or present the user with a web link to BARNES AND NOBLE's® Website for example. Another company/advertiser such as BORDERS® bookstore could decide that they want to purchase the rights, by paying an operator of the visual search server 54, to have all of the advertisements re-routed to the user of the mobile terminal 10 with advertisements or product information from BORDERS® bookstore. In this regard, when the user of mobile terminal 10 points the camera module 36 at a bookshelf (or captures a picture of a bookshelf) or any other object associated with the meta-information established in the tags created by BARNES AND NOBLE®, the visual search server 54 will re-route the user to an advertisement for BORDERS® bookstore and/or present the visual search client of the user with the address or link for BORDERS® Website. In this regard, the visual search server 54 uses tags, objects and content that was previously set up and stored in the visual search database by a prior advertiser to re-route advertisements or web links, for a current advertiser, to the user terminal based on the camera module 36 when it is pointed to or captured an image that was sent to the visual search server. By using the camera module 36, the visual search client is utilizing visual searching (as opposed to keyword or text based searching). The re-routing of tags can be constrained by location, time or any other contextual information. In view of the above, information in the original tag set up or created by the original advertiser can either be replaced or re-routed to a new location.

The tag re-routing implementation of the current invention, in large part, operates independently of the visual search database 51. For example, all the service-based actions can be re-routed to the different service or advertiser without any changes to the existing or current state of the visual search database 51. As such, the tag re-routing implementation has an impact on a service recommendation but no specific changes to the visual search database. This implementation can offer flexibility to advertisers, particularly to those who do not want to insert objects to the visual search database as their needs may be only temporary such as special campaigns or seasonal advertising schemes and the like.

Service Advertisement (Ad) Insertion: The service ad insertion implementation refers to inserting advertisements when a particular service is invoked by the visual search client 68. This implementation allows advertisers to display their advertisements when a particular service is being presented to the user of the mobile terminal, such as a banner or frame around a particular service. In the service ad insertion implementation, the advertiser may utilize the visual search advertiser input control/interface 98 to insert objects and associated information in the visual search database 51 which may also be uploaded, sent, or transmitted to the visual search server 54. These objects stored in the visual search database and the visual search server 54 may form a list of candidates that may be provided to the visual search client 68 of the mobile terminal. When the user points the camera module 36 at a corresponding object having information (i.e., information tied to or associated with meta-information) similar to the objects stored in the visual search server on behalf of the advertiser, the user may receive corresponding advertisement media from a first advertiser as well as an inserted advertisement from a second advertiser. For instance, suppose the user of the mobile terminal 10 points the camera module 36 at a VOLKSWAGEN car on a street (or captures an image of the VOLKSWAGEN car) the visual search server 54 may provide the visual search client 68 of the mobile terminal 10 with a an advertisement from VOLKSWAGEN or provide the user with a link to VOLKSWAGEN's Website (in this example, the first advertiser). If another advertiser, such as for example, AUTOTRADER, pays an operator of the visual search server 54 for the service ad insertion implementation service of this exemplary embodiment of the present invention, the advertisement from VOLKSWAGEN could have, inserted into it, an advertisement from AUTOTRADER. For instance, the advertisement from AUTOTRADER could be presented around a border of the VOLKSWAGEN advertisement. Additionally, the advertisement from AUTOTRADER could be presented (i.e., inserted) to the display 28 of the mobile terminal 10 prior to the advertisement from VOLKSWAGEN being presented to the display 28 of the mobile terminal. In addition, prior to presenting the user of the mobile terminal 10 with the Website for VOLKSWAGEN, the user of the mobile terminal could first be provided the Website for AUTOTRADER for a predetermined amount of time and then when the predetermined time expires the user of the mobile terminal can be provided with VOLKSWAGEN'S Website. Alternatively, an advertisement from VOLKSWAGEN could be provided to the user of the mobile terminal 10 by the visual search server 54 and when that advertisement is no longer displayed on display 28, the user could be immediately provided the advertisement from AUTOTRADER, for example.

Furthermore, in the service ad insertion implementation, a user of the mobile terminal 10 may point his/her camera module 36 at a business such as for example a restaurant and the visual search server 54 provides the visual search client 68 with a phone number of the restaurant and the visual search client of the mobile terminal 10 thereby may call the restaurant. However, during the telephone call to the restaurant, (or prior to a connection of the telephone call with the restaurant) the user of the mobile terminal could be provided, via the visual search server, with an advertisement such as for example, a text message to buy flowers from a flower shop or a phone call soliciting the purchase of flowers from the flower shop. This advertisement could also be in the form of an audio clip, video clip or the like to purchase flowers from the flower shop prior to connecting the user with the restaurant.

A second advertiser purchasing rights to the service ad insertion implementation and the associated advertisement has no restrictions on the relevancy of the service. As such, it has no impact on the service or the content in the visual search database.

Point Advertisement (Ad) insertion: The point ad insertion implementation relates to inserting advertisements when a particular object is viewed, by the camera module 36 for example during the time of pointing the camera module 36 at a specific object, prior to a particular service being invoked. In the point ad insertion implementation, once the camera module is pointed at a particular object, the display 28 of the mobile terminal 10 is capable of displaying the ad instantly/inline. For instance, an advertiser could use the visual search advertiser input control/interface 98 to associate information to objects or POIs (i.e., tags) and store the information and corresponding objects in the visual search database 51. The information associated with the objects could be media data including but not limited to text data, audio data, images, graphical animation, video clips and the like which may relate to one or more advertisements. As discussed above, the information associated with the objects could also consist of meta-information, including but not limited to geo-location (as used herein geo-location includes but is not limited to a relation to a real-world geographic location of an Internet connected computer, mobile device, or website visitor based on the Internet Protocol address, MAC address, hardware embedded article/production number, embedded software number), time, season, location (e.g., location of object(s) pointed at or captured by camera module 36), information relating to a user of a mobile terminal, users of groups of mobile terminals, weather, temperature and the like. The objects could correspond to one or more products marketed and sold by the advertiser, such as for example (and merely for illustration purposes) PEPSI products, VOLKSWAGEN products, etc.

The information associated with the objects stored in visual search database 51 could be sent, transmitted or uploaded or the like to the visual search server 54 (or the visual search server 54 may download the information associated with the objects from the visual search database). When a user of a mobile terminal 10 points his/her camera module 36 at an object(s) (e.g. PEPSI can or a VOLKSWAGEN car on a street) or captures an image of an object(s) related to objects stored in the visual search server 54 on behalf of the advertiser, the visual search server 54 receives an indication of the object pointed at or captured from the visual search client 68 and immediately provides the visual search client 68 of the mobile terminal, an advertisement related to the object pointed at or a corresponding captured image. For instance, in this example, if the user of the mobile terminal 10 pointed the camera module at a VOLKSWAGEN car on the street, the visual search server 54 would immediately select an advertisement from a list of candidates and provide the visual search client 68 with an advertisement media (which could be related to VOLKSWAGEN cars) which is instantly displayed on the display 28 of the mobile terminal.

The list of candidates from which the visual search server selects an advertiser could be from a list of any number of advertisers or entities purchasing rights from an operator of the visual search server 54 to provide users of mobile terminals with advertisement media. For instance, in the above example, when the user points the camera module 36 at an object such as a VOLKSWAGEN car, the visual search server may select from a list of candidate advertisers such as FORD, CHEVROLET, HONDA, local car dealerships and the like. As such, the visual search server 54 could provide the user of the mobile terminal 10 with advertisement media from FORD for example, when the user points the camera module of the mobile terminal 10 at a VOLKSWAGEN car or any other car or object tied to or associated with the meta-information (for e.g., time of day where the user pointed at or captured an image of the object) set up and established by the advertiser. In this regard, an advertiser in the point ad service implementation may determine various ads to provide a user of a mobile terminal based on objects pointed at by the camera module 36 of the mobile terminal 10. As noted above, the advertisements can be of any form ranging from simple text to graphics, animations and audio-visual presentations and the like. The point ad insertion implementation has no impact on the particular service or the content in the visual search database 51.

Access to Global links: The access to global links implementation relates to the global links in which the visual search database and/or the visual search server contains a pre-determined set of global objects and associated tags that are independent of a particular location of a mobile terminal, or any other contextual information. For example, objects stored in the visual search database 51 or the visual search server 54, by a content provider or an operator, related to weather, news, stock quotes, etc. are typically independent of a particular image captured by a user of mobile terminal or contextual information. These objects may also be stored in a memory element of the mobile terminal 10 to facilitate efficient look-up and avoidance of round-tripping to the visual search server and/or the visual search database. As used herein, global links include but are not limited to physical objects which may serve as symbols for certain things and which are created by a content provider or an operator irrespective of objects or images created or generated by an advertiser or the like. For instance, an object pre-stored in the visual search database 51 and/or the visual search server 54 may be the sky (for e.g.) and the sky may serve as a symbol for weather. In this regard, the object of the sky serves as a global link. The sky is global in the sense that a content provider or an operator of the visual search database 51 and/or the visual search server 54 may load a corresponding object of the sky into the database 51 and the server 54, irrespective of objects loaded into visual search database 51 by an advertiser(s). Another example of a global link could be objects such as street signs stored in the visual search database and/or the visual search server by a content provider or an operator. The stored objects of the street signs could serve as symbols for directions, map data or the like. An advertiser could pay the content provider or operator of the visual search database and/or visual search server 54 for the rights to provide the user of mobile terminal 10 an advertisement(s) based on the camera module 36 being pointed at or capturing an image of an object relating to the global link. For example, THE WEATHER CHANNEL could pay the content provider or operator of the visual search database and/or the visual search database for the rights to provide a user of the mobile terminal 10 with advertisement media or a web link when the user of the mobile terminal points the camera module 36 at the sky (which serves as a symbol for weather as noted above). For instance, when the user of the mobile terminal points the camera module at the sky, the visual search server 54 may send the visual search client 68, a web link of THE WEATHER CHANNEL's Website. Prior to sending the visual search client 68 the advertisement media or a web link or the like, the visual search server 54 may access a list of candidates (THE WEATHER CHANNEL, ACCUWEATHER, local weather stations, etc.) and select a candidate (e.g., THE WEATHER CHANNEL) from the list in which to provide an advertisement or web link to the visual search client 68 of the mobile terminal that is displayed by display 28.

Further one advertiser may purchase the rights to use the global links of the content provider or operator of the visual search database 51 and/or the visual search server 54 in one geographic region and another advertiser may purchase rights to use the same global link(s) of the content provider or the operator in another geographic region. In the example above, THE WEATHER CHANNEL could purchase rights in one geographic area (e.g., California) to use the sky to provide the user of the mobile terminal 10 with an advertisement or web link on behalf of THE WEATHER CHANNEL whereas ACCUWEATHER may purchase the rights to use the sky (i.e., the global link) in another geographic area (e.g., New York) to provide the user of the mobile terminal 10 with an advertisement or web link on behalf of ACCUWEATHER.

As illustrated above, in the access to global links implementation, advertisers can gain exclusive access to stored global objects (i.e., links) and associate their advertisements to these global objects. In this regard, whenever a service is requested for these global objects, the advertiser can present their advertisements to the users of the mobile terminals. It should be pointed out that the access to global links implementation impacts a service recommendation. However, the global links implementation does not impact the objects stored in the visual search database 51 in the sense that these global objects (i.e., links) are stored by the content provider or an operator of the visual search database 51. As such, no new content or objects need to be stored in the visual search database 51 and/or the visual search server 54 by an advertiser(s) who wishes to purchase advertising rights using the global links implementation.

In an alternative exemplary embodiment of the visual search system of FIG. 3, the system is capable of performing 3D reconstruction of image data. The camera module 36 of the mobile terminal 10 may be pointed at one or more POIs and corresponding images are thereby captured. These captured images may be sent by the mobile terminal 10, via antenna 12, to the visual search server 54. The captured image contains information which may not contain information relating to the position of the actual object in the image(s). As such, the visual search server 54 uses the information relating to a position or geographic location from which the image was taken, performs a computation on the images and extracts features from the images to determine the location of objects such as, for example, POIs in the captured images. Additionally, the visual search server 54 computes, for each received captured image, the image's associated POI as well as the visual features extracted from the POI. With respect to single POIs which typically have limited accuracy, the system of this exemplary embodiment of the present invention improves the accuracy of the POI by reconstructing a 3D representation of a corresponding street scene, identifying the likely objects, and using the ordering of the POI's along the street to assign them to the buildings, therefore improving the accuracy of the POI. Additionally, for POI databases that only have single POIs, the system of this exemplary embodiment of the present invention enhances this information by automatically computing richer geometric information. Moreover, the system of the this exemplary embodiment is capable of providing an interface for business owners to create a virtual store front in the system by providing images of their store or business (or any other physical entity) and by providing waypoints (which includes but is not limited to sets of coordinates that identify a point in physical space that may include but are not limited to coordinates of longitude, latitude and altitude) marking the extents of the store, (or other physical entity, e.g., a building) along with the information they wish to present to the user. When the user points a mobile terminal having a camera at the storefront, the system can determine which store is being viewed and present to the user of the mobile terminal, information relating to the store or business.

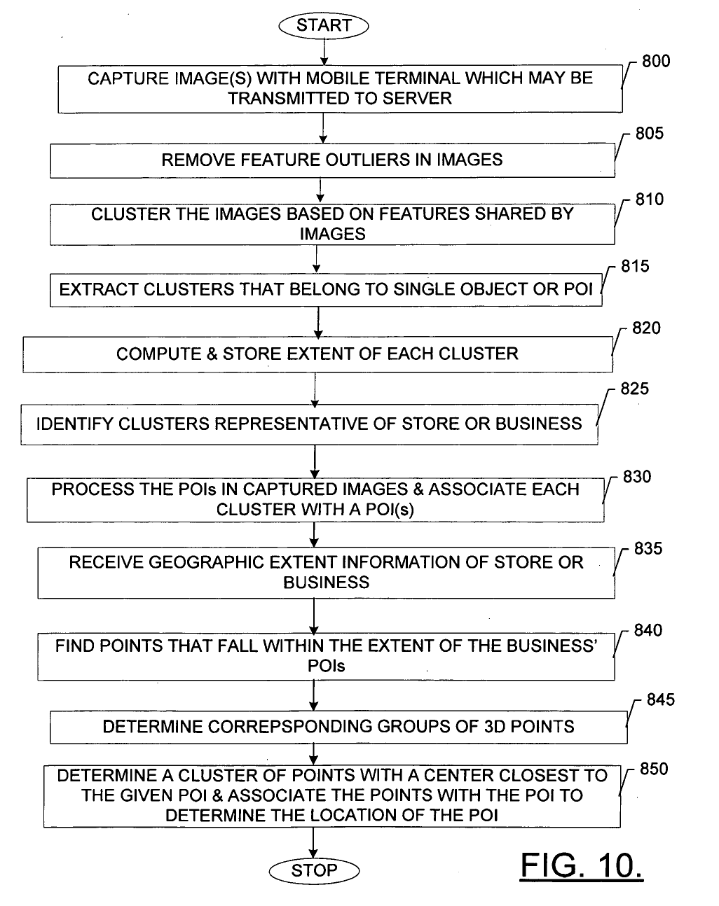

Referring now to FIG. 10, a flowchart for associating images with one or more POI(s) to determine the location of the POI is illustrated. Consider a scenario in which a set of images of stores or businesses, or other physical entities such as those taken while walking along a commercial block or a street in a city. As noted above, the user of a mobile terminal 10 may point the camera module 36 of the mobile terminal at a physical entity (i.e., POI) along the commercial block or street and capture a corresponding image(s) which may be transmitted to the visual search server 54. (Step 1000) The centralized POI database server 74 of the visual search server 54 may store or contain, POI data, (as well as other data) the POI data contains a location of each business along the street, its name and address, and other associated information (such as for example virtual coupons, advertisements, etc). This POI data can be provided as a single location for each business, which is typically of limited accuracy, or as the coordinates of the extents (i.e., start and end) of the business along the street. The regular POI data can be obtained from various map providers, (such as for example Google Maps, Yahoo Maps, etc.) For instance, maps could be retrieved from service providers via the Internet 50 and be stored in map server 96. However, the extent data can be provided by the business owners themselves by uploading the extent data pertaining to their business(s) to the point-of-interest shop server 51 and transferring this POI data to the map server 96 of the visual search server 54.

The centralized POI database server 74 may consist of multiple overlapping images of stores along a street. For example, there may be at least two to three images for each storefront. The visual search server 54 can utilize computer vision techniques to identify interesting visual features in these multiple images and match the features occurring in different images to each other. For example, the mobile visual search server 54 may identify features in at least three images of a corresponding storefront to each other. The visual search server 54 employs techniques to remove feature outliers such as those that correspond to cars, people, ground, etc. (i.e., background objects) and are left with a set of feature points belonging to the facades of a corresponding store or stores (or other physical entity). (Step 1005)

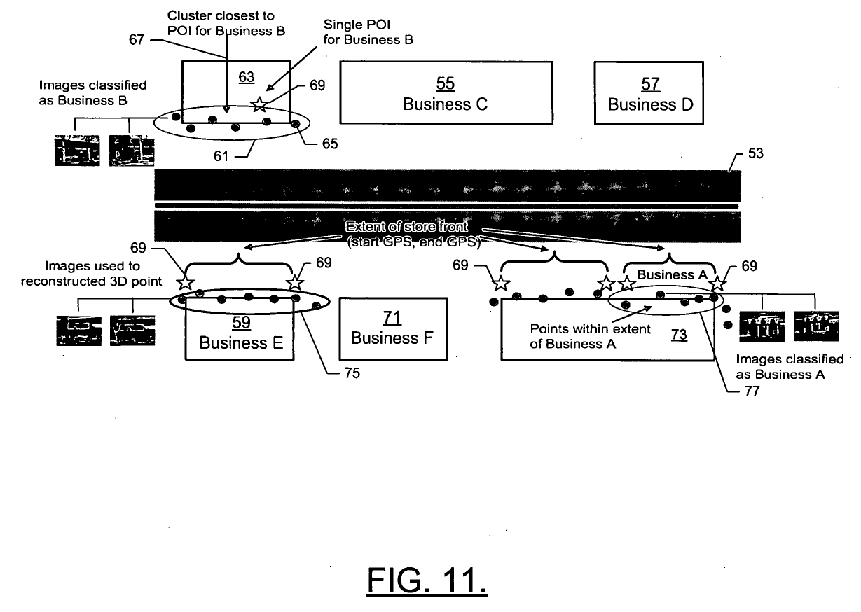

The visual search server 54 clusters the images based on the number of similar features the images share. (Step 1010) For example, if the visual search server identifies a group of images that have a high number of similar features, this group of images is considered to be a cluster. (See e.g., FIG. 11) The size of the cluster can be determined by counting the number of times similar features appear. Once the visual search server 54 determines the image clusters (similar group of images) computed from the feature clusters (i.e., images having similar features), this information is used to compute the physical location of the features using techniques in computer vision art known as “structure and motion.” However, the remaining data processing is performed using 3D locations of features.

Referring now to FIG. 11 an overview of the system for associating images with POIs is illustrated. Given the computed 3D locations of features performed by the visual search server 54 above, the visual search server 54 extracts clusters 61 that are likely to belong to a single object or single POI such as for example single POI Business B 63. (Step 1015) As such, the visual search server 54 aggregates the nearby points 65, which are illustrated as 3D points within the cluster 61 that are reconstructed by image matching, together into clusters 61. Each cluster now can correspond to one or more businesses. The visual search server 54 computes and stores the extent of each cluster, its orientation (which is approximately the same as the street) and its centroid 67. (Step 1020)

In an alternative exemplary embodiment, the visual search server 54 determines the number of businesses located along a single block, and uses that number to explicitly set or establish the number of clusters. The visual search server 54 also utilizes other semantic information extracted from the images, such as business names extracted using Optical Character Recognition (OCR) to assist in clustering the visual features. The visual search server 54 can also use image search information and semantic information which can be added into the visual features for images for which location information is not available.

The visual search server next identifies clusters that are likely to represent a store or business, as opposed to clusters representing some other physical entity. (Step 1025) The visual search server utilizes clusters that contain enough points, or clusters that correspond to a specific shape, i.e. clusters that are roughly planar and oriented along the same direction as the street to determine if the clusters identify a store or business. The visual search server may also associate the feature clusters with information from geographic information system (GIS) (which includes but is not limited to a system for capturing, storing, analyzing and managing data and associated attributes which are spatially referenced to the earth) database.

Next, the visual search server 54 performs processing on one or more POIs in captured images sent from the mobile terminal 10 and which are received by the visual search server and the visual search server associates with each cluster one or more POIs such as, for example, a single POI for business B 63. (Steps 1030)

The visual search server is provided with the geographic extent (start point and end point) information of the businesses along the street which may be provided by owners of the businesses as noted above. (Step 1035) By using the geographic extent information, the visual search server 54 is able to project all points (such as 3D points 65) along the street 53 and find the points that fall within the extent of the businesses POI's (for example Businesses B 63, Business C 55, Business D 57, Business E 59, Business F 71, Business A 73). (Step 1040) Due to errors in measurements, there may not be a perfect alignment of feature clusters with the geographic extents, but typically there is a small number of possible candidates (such as only one or two possible candidates) and the visual search server 54 can uniquely determine the corresponding groups of 3D points 65 which are reconstructed by image matching. (Step 1045) Once the correspondence is determined, feature clusters are associated with a given POI.

By using the foregoing approach, the visual search server 54 can be provided with only a single point for the POI, and accurately determine the location of the POI. Similarly, as can be seen in FIG. 8, the visual search server 54 can be provided with several points possibly corresponding to a POI and accurately determine the location of the POI. The visual search server 54 then determines a cluster of points 61 whose center 67 is the closest to the given POI and associates these points with the POI (e.g. Business B 63 or Business A 73). (Step 1050) As such, the extent(s) can be computed in 3D and the respective feature points can be added to the POI database.

In an alternative exemplary embodiment, the visual search server 54 may be provided with a single GPS location or a small number of GPS locations 69, for each store, business or POI. These GPS location(s) may be generated and uploaded by the business owners, to the local POI database server of the point-of-interest shop server and then uploaded to the visual search server 54. Alternatively, the GPS location(s) may be provided to the visual search server 54 by external POI databases (not shown). Due to the small number of GPS locations 69 for a given POI provided to the visual search server, there may initially be a certain level of uncertainty regarding the precise location of the POI. This imprecision typically occurs when the GPS coordinates are generated by linearly interpolating addresses along a city block. Typically, the POI is located within the correct block, and the ordering of the POI's along the block is correct, but the individual locations of the POIs may be inaccurate. However, exemplary embodiments of the present invention are capable of reconstructing the geometry of the street block and ordering the POIs and clusters along the block to associate the POI's with the clusters and therefore improve the quality of the POI's location.

In order to improve the quality of the POI's location, the visual search server 54 determines the number of k POIs, for a given block, which are situated along a given side of a street. The visual search server can associate a given POI to the correct side of the street based on the address of the POI. (See e.g., Business E 59, Business F 71, Business A 73 situated along the bottom side of street 53 of FIG. 11) The mobile visual search server 54 then extracts k best clusters along the same side of the street based on the reconstructed geometry of the street block. Although the location of the POI may not correspond to the center of the clusters (especially if locations were interpolated from addresses), the order along the street is the same. In this regard, the visual search server, assigns the first POI (Business E 59) to the first cluster (e.g., 75), the second POI (e.g., Business A) to the second cluster, (e.g. 77) etc. As a result, the new location for the POI becomes the center of the cluster, and all points within the cluster are associated with the POI.

Additionally, for each 3D point 65 that is reconstructed, the visual search server identifies the set of images from which each point was extracted. Since the visual search server associates the 3D points and POI's by clustering, as discussed above, the respective association can be transferred to an input image(s), i.e., an image captured by the camera module 36 of the mobile terminal 10 and sent to the visual search server 54. In this regard, the visual mobile server causes each 3D point to assign to its image(s) a respective POI, and for each image a POI is chosen which was assigned to the image having the most points. Since some images can depict several stores, the visual search server can also assign to each image all POI's which received more than a predetermined number of 3D points. A similar process can be used for image matching. For example, visual features may be extracted from an input image and are matched to the visual features in the visual search server. The information relating to the POI that receives the most matches from its visual features is sent from the visual search server 54 to the mobile terminal 10 of the user.

In another exemplary embodiment, an online service for generating a virtual storefront is provided. The online service enables users such as business owners to submit images of their business storefront using a GPS equipped camera (such as mobile terminal 10 having GPS module 70 and camera module 36) and then mark the waypoints that outline the footprint of their business using a GPS device, such as GPS module 70. The business owners could also use a terminal such as mobile terminal 10 to provide (and attach links, such as URLs) relevant information related to the business (such as product information or business contact information, advertising and the like) that they would like to be displayed to a user of a mobile terminal passing by or in a predefined proximity of their store. In this regard, embodiments of the present invention provide a new format for points-of-interest, which not only stores the location of a business, but also the extents of the business' footprint and the associated image data/visual features to be used in a mobile visual search. The relevant data selected by the business owner may be transmitted to the visual search server and be automatically converted into a virtual storefront (such as an online website for the business) using software algorithms stored in the visual search server 54 or performed by an operator of the visual search server. The virtual storefront is indexable using not only location, but also visual features extracted from images or photographs provided by the business owner(s) to the visual search server via the point-of-interest shop server 51, for example. As such, embodiments of the present invention provide a manner in which, users utilizing a camera (such as camera module 36 of mobile terminal 10) can obtain information about a business by simply pointing at the business while walking down the street. Data on the virtual storefront can also be used for visualization purposes either on PC or a mobile phone such as mobile terminal 10, as noted above.

In view of the foregoing, exemplary embodiments of the present invention are advantageous given the use of 3D reconstruction to automatically associate POI data with visual features extracted from location-tagged images. The clustering of visual features in space allows automatic discovery of objects of interest, e.g., store fronts along a street. The location computed by 3D reconstruction gives a better estimate of the location of the object (e.g. a store) than just using the camera positions of the images that show the object, since these images could have been taken from a significant distance away. Using the computed 3D location, the location of the POI data can be automatically improved and information relating to a POI may be automatically associated with the images of a store. As described above, this process is largely automatic and utilizes availability of a database of POIs as well as a collection of geo-tagged images. As noted above, there may be several geo-tagged images corresponding to a single object or POI (e.g., a store front). These geo-tagged images can be provided by users of mobile terminals, as well as businesses interested in providing location-targeted advertising to mobile devices of users.

It should be understood that functions of the visual search system shown in FIG. 3, and that each block or step of the flowcharts of FIGS. 4, 9 and 10 can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions implemented by the visual search system of FIG. 3 and each block or step of the flowcharts of FIGS. 4, 9 and 10. These computer program instructions may also be stored in a computer-readable memory that can direct a computer or other programmable apparatus to function in a particular manner, such that the instructions stored in the computer-readable memory produce an article of manufacture including instruction means which implement the functions carried out by the visual search system of FIG. 3 and each block or step of the flowcharts of FIGS. 4, 9 and 10. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method, comprising:
capturing an image of one or more objects;
analyzing data associated with the image to identify at least one object of the objects of the image;
receiving information that is associated with the at least one object; and
displaying the information that is associated with the at least one object.

2. The method of claim 1, wherein receiving information comprises a map of the area in which the at least one object is located, the map comprises one or more visual tags containing content that is linked to or associated with the object.

3. The method of claim 2 wherein at least one visual tag of the visual tags corresponds to a geographic location of the object and the other visual tags are located in an area within a predefined distance of the at least one visual tag.

4. The method of claim 2, wherein at least a portion of the content of the visual tags comprises data associated with an image of an object with which the visual tag is associated.

5. The method of claim 2, further comprising selecting a visual tag among the visual tags and switching a view of the display and displaying the image of the selected visual tag while excluding from display each of the other visual tags.

6. The method of claim 2, wherein each of the images of the visual tags relates to an object that is in the same category as the objects of the captured image.

7. The method of claim 1, further comprising automatically receiving one or more visual tags comprising data associated with an image of an object with which a respective visual tag is associated based on a proximity to at least one object that was captured in the image.

8. The method of claim 1, wherein prior to displaying the information the method further comprises:
defining metadata associated with at least one object of the image; and
linking the object and the metadata to generate one or more visual tags;

9. A method, comprising:
defining and associating meta-information with one or more objects;
receiving one or more captured images of objects from a device; and
automatically sending media data associated with at least one object to the device, when the captured images received from the device comprise data that corresponds to at least one of the one or more objects.

10. The method of claim 9, wherein automatically sending comprises identifying information in the images and matching the identified information with the associated meta-information.

11. The method of claim 10, wherein automatically sending comprises generating a list of candidate media data to be provided to the device.

12. The method of claim 9, wherein prior to automatically sending media data, the method further comprises determining a geographical location of the device and choosing the media data based on the geographical location.

13. The method of claim 9, wherein automatically sending the media data comprises using the meta-information associated with a first entity to send the media data to another entity.

14. The method of claim 9, wherein when the captured images correspond to data associated with a first entity, automatically sending comprises sending the media data to the device on behalf of a second entity that is different from the first entity.

15. The method of claim 9, wherein the media data comprises first and second parts, the first part comprises a first advertisement and the second part comprises a second advertisement that is inserted within the first advertisement.

16. The method of claim 9, wherein automatically sending comprises generating a list of candidates and selecting at least one candidate, of the candidates, from the list, the media data is sent to the device on behalf of the at least one candidate.

17. A method, comprising:
defining and storing one or more objects;
receiving one or more captured images of one or more objects from a device; and
automatically sending media data to the device, when the captured images received from the device comprises data that is associated with at least one of the defined objects.

18. The method of claim 17, wherein automatically sending comprises sending the media data to the device on behalf of an entity that paid a fee for the media data to be sent.

19. The method of claim 17, wherein defining comprises linking the one or more defined objects to a respective one of a plurality of media data.

20. A method, comprising:
receiving one or more captured images of one or more objects;
removing one or more features from the images;
generating a group of images, from among the images, that share at least one common feature, wherein each of the images of the group are associated with a point;
determining whether the group is associated with a shape of an object captured in one of the images based on a predetermined number of points corresponding to the images of the group;
associating the group to a single object when the determination reveals that there are a predetermined number of points; and
determining the location of at least one object in the images on the basis of the points.

21. The method of claim 20, wherein prior to determining the location, evaluating the coordinates of one or more physical entities along a roadway and identifying the points that are within an area associated with the coordinates.

22. The method of claim 21, further comprising determining a center point among the points that is closest to the coordinates and associating the points with an object of the captured images.

23. The method of claim 22, further comprising utilizing the associated points to determine the location of the at least one object.

24. An apparatus comprising a processor configured to:
capture an image of one or more objects;
analyze data associated with the image to identify at least one object of the objects of the image;
receive information that is associated with the at least one object of the images; and
display the information that is associated with the at least one object.

25. The apparatus of claim 24, wherein the processor is configured to receive information that comprises a map of the area in which the at least one object is located, the map comprises one or more visual tags which contain content that is linked to or associated with the object.

26. The apparatus of claim 25, wherein at least one visual tag of the visual tags corresponds to a geographic location of the object and the other visual tags are located in an area within a predefined distance of the at least one visual tag.

27. The apparatus of claim 25, wherein the processor is further configured to select a visual tag among the visual tags and switch a view of the display and display the image of the selected visual tag while excluding from display each of the other visual tags.

28. An apparatus, comprising a processor configured to:
define and associate meta-information with one or more objects;
receive one or more captured images of objects from a device; and
automatically send media data associated with at least one object to the device, when the captured images received from the device comprise data that corresponds to at least one of the one or more objects.

29. The apparatus of claim 28, wherein the processor is configured to automatically send media data by identifying information in the images and matching the identified information with the associated meta-information.

30. The apparatus of claim 29, wherein the processor is configured to automatically send media data by generating a list of candidate media data to be provided to the device.

31. An apparatus, comprising a processor configured to:
define and store one or more objects;
receive one or more captured images of one or more objects from a device; and
automatically send media data to the device, when the captured images received from the device comprises data that is associated with at least one of the defined objects.

32. The apparatus of claim 31, wherein the processor is configured to automatically send media data by sending the media data to the device on behalf of an entity that paid a fee for the media data to be sent.

33. An apparatus, comprising a processor configured to:
receive one or more captured images of one or more objects;
remove one or more features from the images;
generate a group of images, from among the images, that share at least one common feature, wherein each of the images of the group are associated with a point;
determine whether the group is associated with a shape of an object captured in one of the images based on a predetermined number of points corresponding to the images of the group;
associate the group to a single object when the determination reveals that there are a predetermined number of points; and
determine the location of at least one object in the images on the basis of the points.

34. The apparatus of claim 33, wherein the processor is further configured to evaluate the coordinates of one or more physical entities along a roadway and identify the points that are within an area associated with the coordinates.

35. The apparatus of claim 34, wherein the processor is further configured to determine a center point among the points that is closest to the coordinates and associate the points with an object of the captured images, and utilize the associated points to determine the location of the at least one object.
